(19) United States
(12) Patent Application Publication
(10) Pub. No.: US 2014/0172587 A1
(43) Pub. Date: Jun. 19, 2014

(54) DYNAMIC FLOOR PRICES IN SECOND-PRICE AUCTIONS

(71) Applicant: MICROSOFT CORPORATION, Redmond, WA (US)

(72) Inventors: Haim Somech, Ramat Gan (IL); Moshe Tennenholtz, Haifa (IL); Moti Gindi, Tel Aviv (IL); Ishai Oren, Tel Aviv (IL)

(73) Assignee: MICROSOFT CORPORATION, Redmond, WA (US)

(21) Appl. No.: 13/715,598

(22) Filed: Dec. 14, 2012

(51) Int. Cl. G06Q 30/02

(52) U.S. Cl. CPC G06Q 30/0275
USPC 705/14.71

(57) ABSTRACT

Systems, methods, and computer storage media having computer-executable instructions embodied thereon that dynamically set floor prices in a second price auction for impressions or events. Advertiser bids for the impressions or events are received by the computer system and used to create a statistical distribution. The advertiser with the highest bid for an impression or event is identified. The statistical distribution excludes bids received from the advertiser having the highest bid. The computer system sets a floor price for the impression or event. The floor price is based on the statistical distribution. The advertiser is charged the maximum of the floor price or the second highest bid received from another advertiser for the same impression. The advertisement associated with the advertiser having the highest bid is selected for display in a webpage that corresponds to the impression or event.

### BACKGROUND

Advertisements are generally selected for display in association with a website using a cost-per-click (CPC) or pay-per-click (PPC) advertisement program maintained by a conventional advertisement platform. In such cases, an advertiser provides a CPC bid or a PPC bid for an advertisement that is used to select an advertisement for display. In some advertisement platforms a combination of the bid and a click-through-rate (CTR) associated with the advertisements are used to select the advertisement.

Oftentimes, an auction is conducted to select the advertisement. Some conventional advertisement platforms use second-price auctions. Generally, the second-price auction is an auction where the advertiser who submitted the highest bid is awarded the item being sold and pays a price equal to the second-highest bid. A search engine or web server may communicate with the advertisement platform to obtain an advertisement corresponding to the highest bidder.

For instance, each time a user searches for a word or phrase at a search engine, the search engine provides the word or phrase to an advertisement platform. The advertisement platform associates advertisements with various keywords. Additionally, the advertisement platform matches keywords with the word or phrase provided by the search engine. The advertisements corresponding with keywords matches are selected as potential display advertisements.

The advertisement platform executes an auction to select an advertisement that is returned to the user. The advertiser with the highest bid may win the auction. In turn, the advertisement platform obtains the potential display advertisement for the winning advertiser. The advertisement, in some embodiments, is sent to the search engine where the advertisement is rendered on a search engine results page. Because the advertisement platform executes a second-price auction, the price that the advertiser pays is not the advertiser's maximum bid price. Instead, the advertisement platform charges the advertiser the minimum amount the advertiser can pay to win the auction. In other words, the lowest amount the advertiser can pay to outbid the next highest bid. The price is calculated by advertisement platform to be the second-highest bid plus 0.01.

The second-price auction executed by the conventional advertisement platform is a sealed-bid auction. The second-price auction is a sealed-bid auction because advertisers do not know what other advertisers are bidding. The highest bidder wins the auction and gets their advertisement placed on specific pages for specific users, but pays the price of the second-highest bidder plus a nominal cost that allows the highest advertiser to outbid the next highest bid. This type of auction awards the advertiser with the highest bid but sells the advertisement slot to the highest advertiser at the price of the second highest bid.

### SUMMARY

Embodiments of the invention relate to systems, methods, and computer-readable media for, among other things, facilitating advertisement selection using second price auctions with a dynamic floor price in an advertisement platform. The advertisement platform may receive one or more bids for an impression or event. The impression may be a user issuing a query having one or more phrases to a search engine that requests one or more advertisements. The event may be a webpage loading one or more advertisement placeholders that request an advertisement from the advertisement platform. The advertisement platform receives bids from one or more advertisers for the impression or event. The advertisement platform selects the highest bidder. In turn, a statistical distribution of advertiser bids for the current impression is obtained. In one embodiment, the statistical distribution excludes bids received from the advertiser with the highest bid. The advertisement platform selects a floor price based on the statistical distribution. Upon identifying the maximum of the floor price and the bid of the next-highest bidder, the advertisement platform calculates a price to charge the advertiser having the highest bid. The price is selected by the advertisement platform such that the advertiser wins the auction over the next-highest bidder without falling below the selected floor price. In turn, the advertisement associated with the winning advertiser is transmitted to the search engine or the server hosting the webpage for rendering.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The embodiments of the invention are described in detail below with reference to the attached drawing figures, wherein:

FIG. 1 is a block diagram of an exemplary computing environment in accordance with embodiments of the invention;

FIG. 2 is a network diagram of an exemplary computing system architecture in accordance with embodiments of the invention;

FIG. 3 is a component diagram of an exemplary advertisement platform in accordance with embodiments of the invention;

FIG. 4 is a plot diagram illustrating exemplary distributions for advertiser bids that are used to select an appropriate floor price in accordance with embodiments of the invention; and

FIG. 5 is a logic diagram that illustrates a method for dynamically selecting a floor price during advertisement selection in accordance with embodiments of the invention.

### DETAILED DESCRIPTION

The subject matter of this patent is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the invention relate to systems, methods, and computer storage media having computer-executable instructions embodied thereon that facilitate selecting an advertisement using a second-price auction. The second price auction is a sealed-bid auction with a dynamic floor. The computer system is configured to dynamically select a floor price for an advertiser. Each advertiser, in certain embodiments, is assigned a floor price. In some embodiments, the floor prices assigned to the advertisers may be different from each other.

The computer system may generate statistical distributions for advertiser bids. Each advertiser may have a corresponding statistical distribution where the bids for the advertiser are removed. For instance, an advertiser that is the highest bidder may be associated with a statistical distribution of bids where the bids for the advertiser are excluded from the statistical distribution. Based on the statistical distribution a floor price is selected for each advertiser.

In some embodiments, a second-price auction is executed on the computer system to select an advertisement. The price that is charged to the winning advertiser is based on the maximum of the bid of the second-highest bidder and the floor price. The computing system selects an advertisement associated with the winning advertiser and transmits the advertisement for rendering.

Accordingly, an optimized floor price is set for online advertising using an advertisement platform that allows the advertiser to bid on impressions or events. The optimized floor price is computed based on advertiser bid statistics gathered from non-winners. The winner pays the maximum of the bid of the second-highest bid and the floor price.

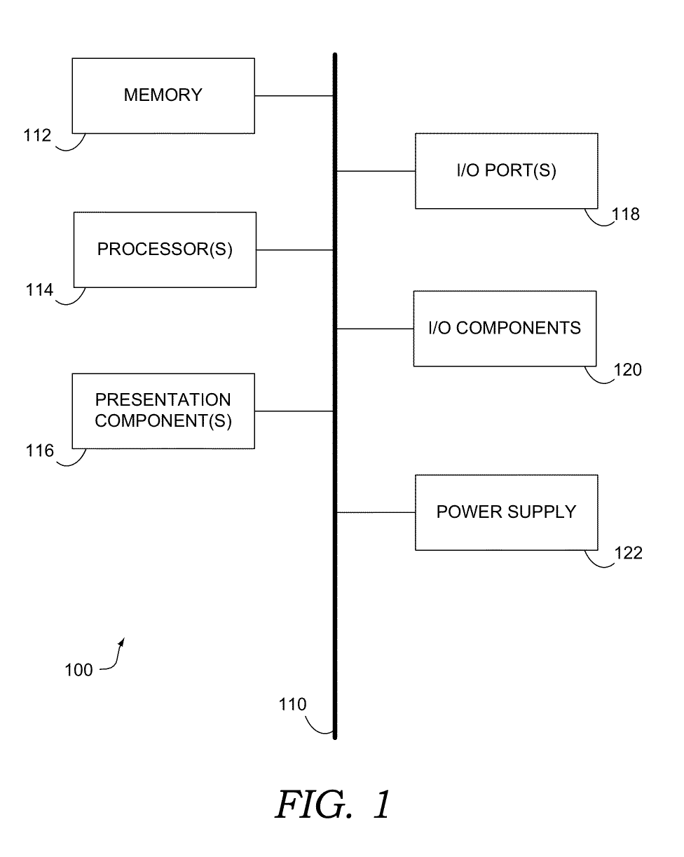

FIG. 1 is a block diagram of an exemplary computing environment in accordance with embodiments of the invention. Having briefly described an overview of the embodiments of the invention, an exemplary operating environment in which various components may be implemented is described below to provide a general context. Referring to the drawings in general, and initially to FIG. 1 in particular, an exemplary operating environment for implementing embodiments of the invention is shown and designated generally as computing device 100.

Computing device 100 is but one example of a suitable computing environment and is not intended to suggest any limitation as to the scope of use or functionality. Neither should the computing device 100 be interpreted as having any dependency or requirement relating to any one or combination of components illustrated. Embodiments of the invention may be described in the general context of computer code or machine-useable instructions, including computer-executable instructions such as program modules, being executed by a computer or other machine, such as a personal data assistant or other handheld device.

Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

As one skilled in the art will appreciate, the computing device 100 may include hardware, firmware, software, or a combination of hardware and software. The hardware includes processors and memories configured to execute instructions stored in the memories. The logic associated with the instructions may be implemented, in whole or in part, directly in hardware logic. For example, and without limitation, illustrative types of hardware logic include field programmable gate array (FPGA), application specific integrated circuit (ASIC), system-on-a-chip (SOC), or complex programmable logic devices (CPLDs). The hardware logic allows an advertisement server to select appropriate advertisements based on, among other things, a dynamic floor price. The advertisement server executes a sealed-bid, second-price, auction to determine a price that a winning advertiser pays to have an advertisement rendered for a corresponding impression or event. The advertisement server identifies statistical distributions of advertiser bids to dynamically set floor prices for the advertisers. The computer device 100 may be an advertisement server, which, in some embodiments, is communicatively connected to a web server or a search engine.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and nonremovable media. Computer-readable media may comprise computer storage media and communication media.

Computer storage media includes volatile and nonvolatile, removable and nonremovable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired data and which can be accessed by the computing device 100. In an embodiment, the computer storage media can be selected from tangible computer storage media like flash memory. These memory technologies can store data momentarily, temporarily, or permanently.

On the other hand, communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components include a microphone, joystick, game pad, satellite dish, scanner, printer, wireless device, a controller, such as, a stylus, a keyboard and a mouse, or a natural user interface (NUI), etc.

The NUI processes air gestures, voice, or other physiological inputs generated by a user. These inputs may be interpreted as search requests, requests for interacting with search results on a search engine results page (SERP), or requests for interacting with a web page displayed by the computing device 100. These requests may be transmitted to the appropriate network element for further processing. The NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes is provided to the display of the computing device 140 to render immersive augmented reality or virtual reality.

Various aspects of the technology described herein are generally employed in computer systems, computer-implemented methods, and computer-readable storage media for, among other things, selecting advertisements. The advertisement platform may create statistical distributions for advertiser bids. The statistical distributions are used to select a price that a winning advertiser pays to have an advertisement rendered for an impression or event received by the advertisement platform.

The advertisement platform is executed on a server that maintains one or more advertisement campaigns. In certain embodiments, the server may execute a second-price auction for impressions or events received at the advertisement platform. The winner of the auction is selected based on the bids and a dynamic floor price selected for the winner. The winner's advertisement is obtained from storage and made available to a user. The advertisement may be rendered on a SERP produced by a search engine. Or the advertisement may be rendered on a webpage provided to the user from a web server.

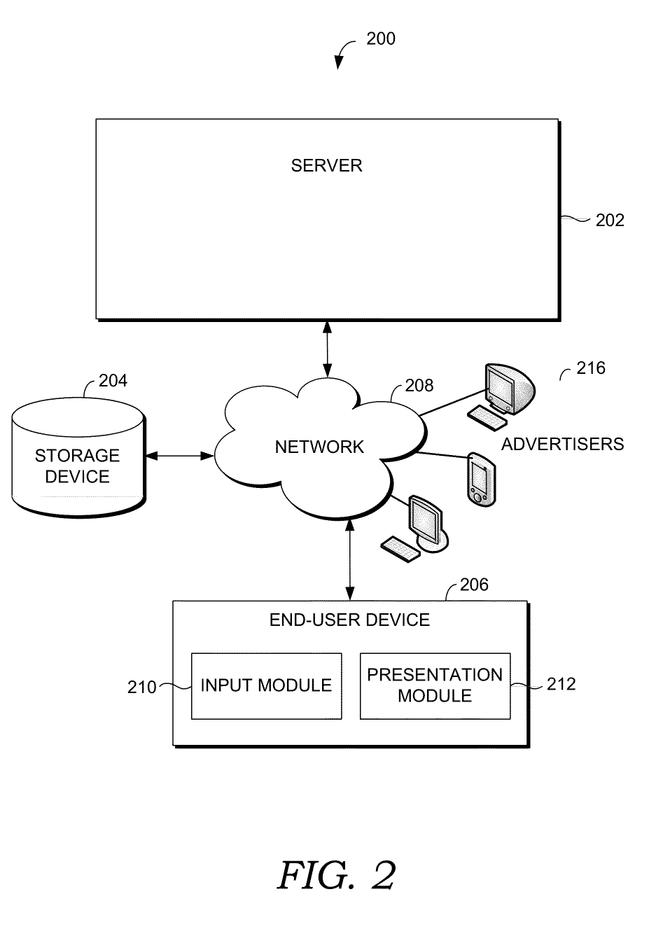

FIG. 2 is a network diagram of an exemplary computing system architecture 200 in accordance with embodiments of the invention. With reference to FIG. 2, an exemplary computing system architecture 200 is illustrated. It will be understood and appreciated by those of ordinary skill in the art that the computing system architecture 200 shown in FIG. 2 is merely an example of one suitable computing system and is not intended to suggest any limitation as to the scope of use or functionality. Neither should the computing system architecture 200 be interpreted as having any dependency or requirement related to any single module/component or combination of modules/components illustrated therein.

Computing system architecture 200 includes a server 202, a storage device 204, an end-user device 206, and advertisers 216 all in communication with one another via a network 208. The network 208 may include, without limitation, one or more local area networks (LANs) and/or wide area networks (WANs). Such networking environments are commonplace in offices, enterprise-wide computer networks, intranets and the Internet. Accordingly, the network 208 is not further described herein.

The storage device 204 is configured to store information associated with advertisement selection. In various embodiments, such information may include, without limitation, advertisements, click rates, click bids, impression bids, impressions, click numbers, advertiser identifiers, floor prices, statistical distributions of advertiser bids, and/or the like. The storage device may include a log for prior auctions. The log may store prior events or impressions, prior bid amounts received, identifiers of prior winning advertisers, and the previously selected sale price of the impression or the event.

In some embodiments of the invention, the storage device 204 is configured to be searchable for one or more of the items stored in association therewith. It will be understood and appreciated by those of ordinary skill in the art that the information stored in association with the storage device 204 may be configurable and may include any information relevant to one or more advertisements. The content and volume of such information are not intended to limit the scope of embodiments of the present invention in any way. Further, though illustrated as a single, independent component, the storage device 204 may, in fact, be a plurality of storage devices, for instance a database cluster, portions of which may reside on the server 202, the end-user device 206, advertiser device 216, another external computing device (not shown), and/or any combination thereof.

The server 202, the end-user device 206, and the advertiser device 216, shown in FIG. 2 may be any type of computing device, such as, for example, computing device 100 described above with reference to FIG. 1. By way of example only and not limitation, the server 202, the end-user device 206, and the advertiser device 216 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof.

The server 202 may include any type of application server, database server, or file server configurable to perform the methods described herein. In addition, the server 202 may be a dedicated or shared server. One example, without limitation, of a server that is configurable to operate as the server 202 is a structured query language (“SQL”) server executing server software such as SQL Server 2005, which was developed by the Microsoft® Corporation headquartered in Redmond, Wash. The server 202 may execute an advertisement platform. The advertisement platform implements the sealed-bid, second price, auction for impressions or events that correspond to an end-user device 206. The server 202 selects an advertisement from storage device 204. The selected advertisement, in storage 204, is associated with the winner of the auction. In turn, the server 202 transmits the selected advertisement to the end-user device for rendering.

While the server 202 is illustrated as a single unit, one skilled in the art will appreciate that the server 202 is scalable. For example, the server 202 may in actuality include a plurality of servers in communication with one another. Moreover, the storage device 204 may be included within the server 202 or end-user device 206 as a computer-storage medium. The single unit depictions are meant for clarity, not to limit the scope of embodiments in any form.

As shown in FIG. 2, the end-user device 206 includes an input module 210 and a presentation module 212. In some embodiments, one or both of the modules 210 and 212 may be implemented as stand-alone applications. In other embodiments, one or both of the modules 210 and 212 may be integrated directly into the operating system of the end-user device 206. It will be understood by those of ordinary skill in the art that the modules 210 and 212 illustrated in FIG. 2 are exemplary in nature and in number and should not be construed as limiting. Any number of modules may be employed to achieve the desired functionality within the scope of embodiments hereof. An end-user device might be used by a user. A user refers to an individual or a group that views an advertisement. Accordingly, a user might navigate to a website or provide a user search query and the like.

The input module 210 is configured for receiving input. Such input might include, for example, search queries or website navigation provided by users. Typically, search requests are input via a user interface (not shown) associated with the end-user device 206 or the like. Upon receiving input, the presentation module 212 of the end-user device 206 is configured for presenting advertisements, for example, in association with search results or a webpage to a user. Embodiments of the invention are not intended to be limited to visual display but rather may also include audio presentation, combined audio/video presentation, and the like.

A marketing person may utilize the advertiser device 216 to provide the server 202 with bids and advertisement campaign triggers. The advertiser device 216 is a computing device that receives inputs or instructions from the marketing person. The marketing person may create, support, or promote an advertisement. The advertiser device 216 may receive click bids or impression bids provided by a marketing person, or the like. The advertiser device 216 is in communication with the server 202 to update advertisement campaigns and to review budgets for the campaigns.

Accordingly, marketing personnel may manage an advertisement campaign via the advertiser devices. The advertisement campaign is executed by the server. In turn, the server obtains the bids from the advertisement campaigns and executes a second price auction to select an advertisement. The second price auction may utilize a dynamic floor to determine an appropriate price to charge a winner. The auction winner is identified, by the server, to select a corresponding advertisement for delivery to the end-user.

The advertisement platform executed by the server includes several components. These components enable the advertisement platform to create a statistical distribution of advertiser bids. In turn, the appropriate floor is selected based on the statistical distribution. The advertisement platform implements the second-price auction and utilizes the floor price and the advertiser bids to select an advertisement for rendering on an end-user device.

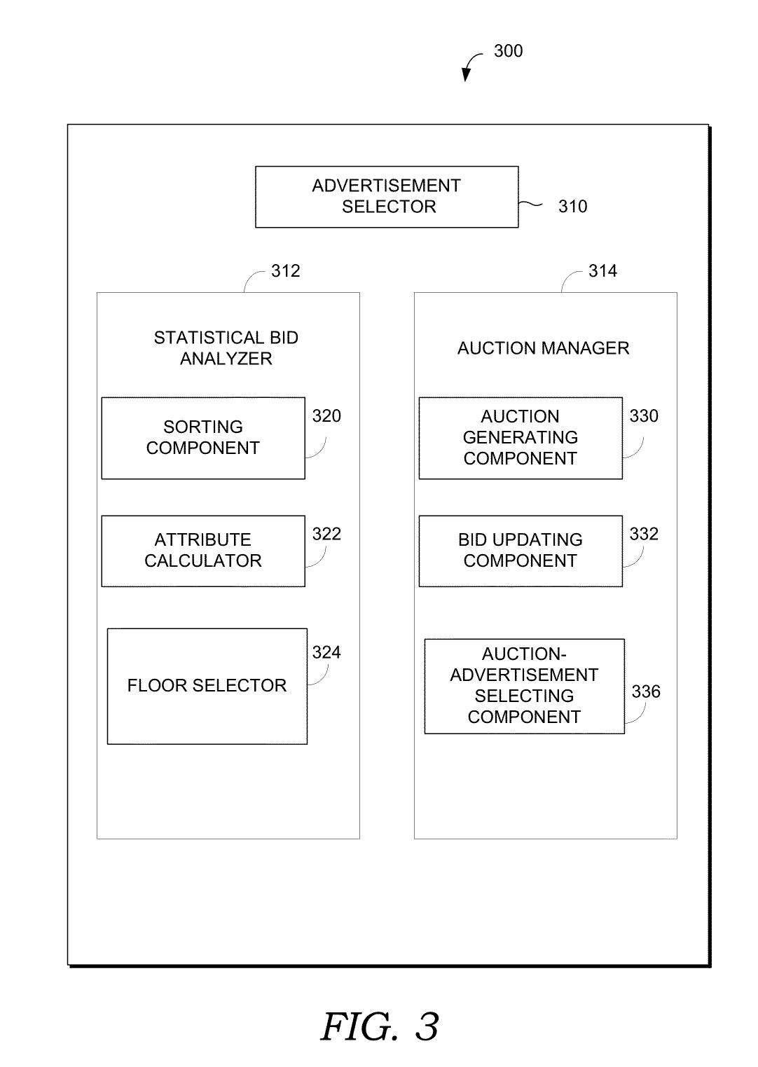

FIG. 3 is a component diagram of an exemplary advertisement platform 300 in accordance with embodiments of the invention. As shown in FIG. 3, an exemplary advertisement platform 300 includes an advertisement selector 310, a statistical bid analyzer 312, and an auction manager 314. In some embodiments, one or more of the illustrated modules/components may be implemented as stand-alone applications. In other embodiments, one or more of the illustrated modules/components may be integrated directly into the operating system of a server executing the advertisement platform, a cluster of servers, an end-user device, or an advertiser device. It will be understood by those of ordinary skill in the art that the modules/components illustrated in FIG. 3 are exemplary in nature and in number and should not be construed as limiting. Any number of modules and/or components may be employed to achieve the desired functionality within the scope of embodiments hereof. Further, modules and/or components may be located on any number of servers or computing devices.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other modules and/or components, and in any suitable combination and location. Various functions described herein as being performed by one or more entities may be carried out by hardware, firmware, and/or software. For instance, various functions may be carried out by a processor executing instructions stored in memory.

The advertisement selector 310 is configured to select an advertisement based on the results of a second-price auction. In certain embodiments, the advertisement is selected based on the statistical distribution of advertiser bids received by the advertisement platform for an impression or event. An advertisement might be requested for display, for example, in association an impression for a search results webpage (e.g., Microsoft's Bing Search Engine) or other webpage. An advertisement might be requested for display, for example, in association an event, e.g., a user clicking on a uniform resource locator (URL) in the search results webpage or other webpage.

By way of example, a user may enter a search query into a search engine or navigates to a particular webpage. In turn, a search engine may generate a SERP having placeholders for one or more advertisements. Or a web server may provide the particular webpage having one or more advertisement placeholders. The advertisement platform 300 may receive a request from the web server or search engine for advertisements to render in the advertisement placeholders. The advertisement platform 300 provides an advertisement to be displayed to the user in association with other content being displayed (e.g., search results or webpage content). In such a case, an advertisement is desired or requested so that the advertisement can be displayed in association with the corresponding webpage.

The statistical bid analyzer 312 creates a statistical distribution of advertiser bids that are used to select an appropriate advertisement. The statistical bid analyzer 312 may include a sorting component 320, attribute calculator 322, and floor selector 324. The statistical bid analyzer 312 obtains advertiser bids for an impression or event. In some embodiments, the advertiser bids include bids from prior auctions for a similar impression or event. The statistical bid analyzer 312 processes the bids to determine various features of the advertiser bid data that may be used to select a floor price. The selected floor price may be used during a second price auction implemented by the advertisement platform 300.

The sorting component 320 sorts the advertiser bids based on the value of the bid. In one embodiment, the bids are sorted from highest to lowest. The highest advertiser bid for the impression is selected as winner of the auction. In turn, the sorting component 320 may resort the bids to exclude bids received from the winner. These bids are used to generate a statistical distribution from which the floor price is selected. In some embodiments, the bids include historical bids for a similar impression.

The attribute calculator 322 obtains the resorted bids that include the historical bids and calculates the values for several attributes. The attributes of the statistical distribution may include, among others, mode, mean, median, etc. The attribute calculator 322 processes the advertiser data to determine the values of the mode, mean, and median attributes. These attributes may be utilized by the advertisement platform 300 to set a floor price for a current auction.

The floor selector 324, in one embodiment, may select a floor price select a floor price based on any one of the following: mode, mean, and median attributes. The mode, mean, and median advertiser bids may be set as the floor price for the current advertiser auction. For instance, the floor selector 324 may set the floor price of to be a mean. Alternatively, the floor price may be the minimum of the top 10% of the bids included in the statistical distribution. The floor selector 324 sets the floor price and provides the floor price to the auction manager 314. The optimal floor price for the advertiser auction may be selected from a learned distribution of advertiser bids, assuming the values of the learned distribution includes advertiser bids that are chosen independently from a distribution similar to the learned distribution.

The auction manager 314 implements the second-price auction. The auction manager 314 communicates with the statistical bid analyzer 312 to obtain the amount of the highest bid, the identity of the advertiser associated with the highest bid, the amount of the second-highest bids, and the floor price. In turn, the auction manager 314 may select an appropriate advertisement for display. The advertisement may be associated with advertiser that provided the highest bid.

The auction manager 314 implements an auction generating component 330, a bid updating component 332, and an auction-advertisement selecting component 336. The auction generating component 330 identifies that impressions and events that are currently the items of interest for the advertisers. The auction generating component 330 obtains bids from storage or from advertisers in real time. The storage may include one or more campaigns that have preconfigured advertiser bids for specific events or impressions.

In turn, a bid updating component 332 may receive additional bids for an impression or event in real time. These bids are sent to the statistical bid analyzer 312 to update the distribution and the floor price, if necessary. The bid updating component 332 may receive bids in real-time until the auction is closed.

Once the auction is closed, the auction-advertisement selecting component 336 obtains an advertisement from the advertiser that provided the highest bid. The auction-advertisement selecting component 336 may also set the price to be paid by the winning advertiser. In one embodiment, the price is set to be the maximum of the floor price or the second-highest bid. In other embodiments, the price is set to be a combination, e.g., sum or product, of the floor price or the second-highest bid. In one embodiment, the price is set to be the minimum of the floor price or the second-highest bid.

Accordingly, the advertisement selector 310 obtains the advertisement of the winning advertiser and provides the advertisement to a search engine or web server for rendering to an end-user. The advertisement platform 300 is configured to execute the second-price auction to reward an advertiser that wins the auction for an impression or event. The second price auction utilizes a dynamically set floor price to select a cost paid by the winning advertiser.

As explained above, the statistical distribution of advertiser bids may include current bids for an impression and historical bids for a similar impression. The advertiser bids may be graphed to determine the characteristics of the distribution. Based on these characteristics, mean, median, or mode, an advertisement platform may select a floor price.

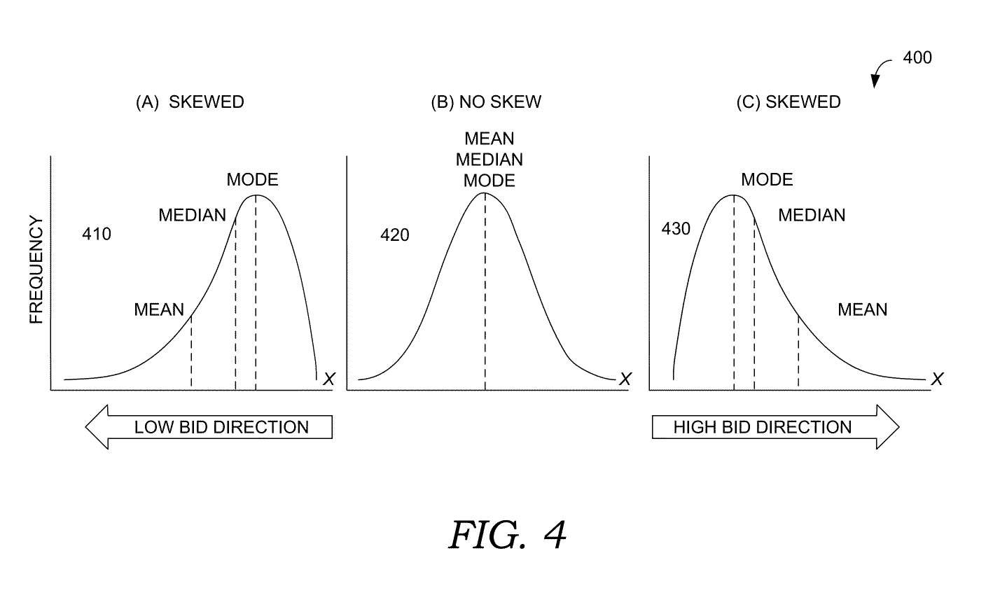

FIG. 4 is a plot diagram illustrating exemplary distributions for advertiser bids that are used to select an appropriate floor price in accordance with embodiments of the invention. The graphs 410, 420, and 430 represent advertiser bid distributions for an impression. The graphs 410 and 420 show skewed graphs of the advertiser bid distribution where advertiser bids are bunched around low bids or high bids. In some embodiments, each advertiser is associated with a distribution that excludes bids from the advertiser of interest. For instance, the advertiser with the highest bid may be associated with a statistical distribution of bids from non-winning advertisers. In other words, the statistical distribution for the advertiser with highest bid excludes all bids from the advertiser with the highest bid.

The graph 420 shows an ideal distribution of advertiser bids. In some embodiments, the advertisement platform may select the floor price based on the skew. For instance, if the bids are skewed in a negative direction, e.g. large numbers of high bids, as illustrated in graph 410, the floor price may set based on the mode or median. If the bids are skewed in the opposite direction, e.g., large number of low bids, then the advertisement platform may select the mean to set the floor price. If the bids are close to an ideal normal distribution, the floor price may be set as any one of the mode, mean or median. In other embodiments, the advertisement platform may always set the floor price to be within the top 20% of the high bids. For instance, the floor price may be smallest bid in the top 10 percent of the advertiser bids.

Accordingly, the floor price is set based on the characteristic identified from the statistical distribution of advertiser bids. The statistical distribution varies for each advertiser. The floor price may be dynamically determined by the advertisement platform upon receiving an impression or event. The floor price may be used by the advertisement platform to select a payment price for rendering an advertisement that corresponds to an impression or event received by the advertisement platform.

In some embodiments, the advertisement platform utilizes a floor price and second-highest bid to set a price for displaying an advertisement. The advertiser with the highest bid is rewarded with a price less than the highest bid for the impression or event that was a subject to the second-price auction. The selected advertisement is delivered to a user after the advertiser is charge the price determined based on either the auction or the floor price set by the statistical distribution.

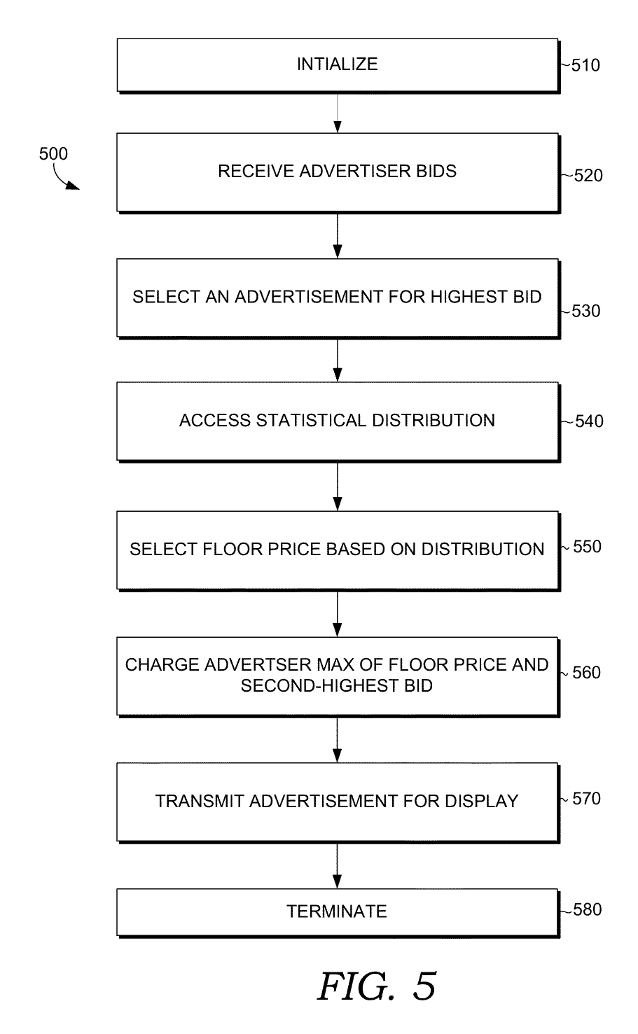

FIG. 5 is a logic diagram that illustrates a method for dynamically selecting a floor price during advertisement selection in accordance with embodiments of the invention. The method initializes in step 510. In step 520, the server may receive advertiser bids from advertisers that seek to promote a good or service. The server, in step 530, selects an advertisement corresponding to the advertiser having the highest bid. The advertiser bids may be for impressions or events. The impressions are associated with placements within a webpage. The events are related to user interaction on the webpage. In some embodiments, the advertiser bids and impressions or events are received in real time.

In step 540, a statistical distribution of the advertiser bids is accessed by the server. In turn, a floor price based on the statistical distribution is selected, in step 550. In one embodiment, the statistical distribution specifies an average, mode, or median. The server may set the floor price based on any combination of the following: the average, the median, or the mode. In certain embodiments, the statistical distribution excludes bids obtained from the advertiser with the highest bid. In other embodiments, the statistical distribution includes data for prior bids received from advertisers that were seeking placement of advertisements for a similar impression or similar event.

The server, in step 560, charges the advertiser a price that is equal to the maximum of the floor price and a second-highest bid, in one embodiment. In step 570, the server transmits the advertisement associated with the advertiser having the highest bid for rendering. The advertisement may be displayed in either of the following environments: a webpage or an application. The advertisement may be any combination of: text, multimedia, video, or audio. The method terminates in step 580.

In summary, the sealed-bid, second-price auction is conducted by an advertisement platform to select a price for the winning advertiser. The advertisement platform may initially execute a second-price auction without a floor price, and record the bids. In a first iteration, the potential winner may be the advertiser with the highest bid. However, after a number of iterations or auctions have been conducted, e.g. 100 auctions for the same impression, the platform may introduce a floor price. For instance, the floor price may be selected by the advertisement platform based on the statistical distribution of advertiser bids gathered on the other advertisers' bids. The floor price to be assigned is almost completely independent from the winner's identity. The advertisement platform supports floor prices that are dynamically determined based on partial statistics as well. In some cases, different floor prices might be assigned to different winning advertisers. The advertisement platform allocates the impression to the advertiser having the highest bid when the bid is higher than the floor price. The advertisement platform makes the impression or event available to advertisers at a price that equals the max between the floor price and the second-highest bid.

The statistical distribution may be a uniform distribution between a low bid and a high bid. In other embodiments, the statistical distribution is a normal distribution. The auction for the same impression may be executed thousands of times per day in real time. In one embodiment, the floor price is determined based on the history of bidding of other advertisers excluding the current advertiser with highest bid.

From the foregoing, it will be seen that embodiments of the invention may attain all the ends and objects set forth above, together with other advantages which are obvious and inherent to the system and method. It will be understood that certain features and subcombinations are of utility and may be employed without reference to other features and subcombinations. This is contemplated by and is within the scope of the claims. The described embodiments are intended in all respects to be illustrative rather than restrictive. Alternative embodiments will become apparent to those of ordinary skill in the art to which the present invention pertains without departing from its scope.

The technology claimed is:

1. A computer-implemented method to select advertisements based on a dynamic floor price, the method comprising:
receiving advertiser bids from advertisers that seek to promote a good or service;
selecting an advertisement corresponding to the advertiser having the highest bid;
accessing a statistical distribution of the advertiser bids;
selecting a floor price based on the statistical distribution;
charging the advertiser a price that is equal to the maximum of the floor price and a second-highest bid; and
transmitting the advertisement associated with the advertiser having the highest bid for display.

2. The method of claim 1, wherein the advertiser bids are for impressions or events.

3. The method of claim 2, wherein the impressions are associated with placements within a webpage and the events are related to user interaction on the webpage.

4. The method of claim 2, wherein the bid and impressions or events are received in real time.

5. The method of claim 1, wherein the statistical distribution specifies an average, mode, or median.

6. The method of claim 5, wherein the floor price is based on the average.

7. The method of claim 5, wherein the floor price is based on the median.

8. The method of claim 5, wherein the floor price is based on the mode.

9. The method of claim 5, wherein the statistical distribution excludes bids obtained from the advertiser with the highest bid.

10. The method of claim 5, wherein the statistical distribution includes data for prior bids received from advertisers that were seeking placement of advertisements in a similar impression or similar event.

11. The method of claim 1, wherein the advertisement is displayed in either of the following environments: a webpage or an application.

12. The method of claim 11, wherein the advertisement is any combination of:
text, multimedia, video, or audio.

13. The method of claim 1, further comprising:
confirming that the highest bid is larger than the selected floor price;
receiving additional bids when the highest bid is less than the floor price from advertisers;
selecting a replacement highest bid from the additional bids, wherein the replacement highest bid is larger than the highest bid;
updating the statistical distribution of the bids including the additional bids that excludes bids from the advertiser that provided the replacement highest bid; and
modifying the floor price based on the updated statistical distribution.

14. A method to select the cost of an impression or event based on a floor price in a computer system configured to execute a second price auction of impressions or events, the method comprising:
obtaining advertiser bids from advertisers;
selecting a highest bid from the advertiser bids;
creating a statistical distribution of the advertisers bids except bids corresponding to the advertiser with the highest bid;
selecting a floor price based on the statistical distribution; and
charging the advertiser with the highest bid a price equal to the maximum of the floor price and the second-highest bid.

15. The method of claim 14, wherein each advertiser is associated with a statistical distribution that excludes bids from the advertiser.

16. The method of claim 14, wherein the statistical distribution specifies an average, mode, or median.

17. The method of claim 14, wherein the advertiser bids are for impressions or events.

18. The method of claim 16, wherein the impressions are associated with placements within a webpage and the events are related to user interaction on the webpage.

19. The method of claim 16, wherein the bid and impressions or events are received in real time.

20. One or more computer storage media having computer useable instructions that cause a computer system to perform a method to select advertisements based on a dynamic floor price, the method comprising:
receiving advertiser bids from advertisers that seek to promote a good or service;
selecting an advertisement corresponding to the advertiser having the highest bid;
accessing a statistical distribution of the advertiser bids;
selecting a floor price based on the statistical distribution;
charging the advertiser a price that is equal to the maximum of the floor price and the second-highest bid; and
transmitting the advertisement associated with the advertiser having the highest bid for display.
